(19) United States
(12) Patent Application Publication
(10) Pub. No.: US 2015/0042294 A1
(43) Pub. Date: Feb. 12, 2015

(54) High accuracy pulse duty-cycle calculation implementation for power converter's PWM control apparatus

(71) Applicants: Qi Cui Wei, Hangzhou (CN); Da Feng Weng, Sunnyvale, CA (US); Zong Bing Li, Hangzhou (CN)

(72) Inventors: Qi Cui Wei, Hangzhou (CN); Da Feng Weng, Sunnyvale, CA (US); Zong Bing Li, Hangzhou (CN)

(21) Appl. No.: 13/987,573

(22) Filed: Aug. 9, 2013

(51) Int. Cl. H02M 3/04

(52) U.S. Cl. CPC H02M 3/04
USPC 323/234

(57) ABSTRACT

The high accuracy pulse duty-cycle calculation hardware implementation scheme is composed of a clock generator block, digital pulse width account block, digital memory block to store pulse width in digital and digital-analog divider block with two digital-analog converters. The digital pulse width account block is used to account the two pulse width of a pulse, e.g. turn-on time T_{ON}, turn-off time T_{OFF}, cycle time T_{S} or other time variable in digital method. The digital memory block is used to store digital information from the digital pulse width account block until next cycle. The digital-analog divider block outputs the ratio of two pulse widths in analog signal based on two stored digital pulse widths from the digital memory block

### BACKGROUND OF THE INVENTION

The present invention relates to the pulse duty-cycle calculation implement scheme. More specifically, the invention relates to high accuracy pulse duty-cycle calculation hardware implementation scheme for several power converter's PWM control apparatus.

In the existing pulse duty-cycle calculation implementation scheme as shown in FIG. 1, there are two steps. The first is to convert a pulse width into a related analog signal and sample-hold the analog signal; The second is to use an analog divider to obtain the ratio of two pulse widths. More particularly, in the first step, the pulse width signal is converted into an analog signal through an integrator circuit, after then the analog signal is sample-holded. In the second step, two sample-holded analog signals are inputted into two inputs of divider to get the ratio of two pulse widths.

Due to a wide and dynamic range of pulse widths, it is hard to implement the integrator and sample-hold circuit with precise accuracy. In general, lots of space is necessary for the integrator and sample-hold circuit. Due to the wide and dynamic range of divider outputs, the analog divider is generally both limited in accuracy and complicated in structure. Currently, implementation of the original pulse duty-cycle calculation scheme is very costly and imprecise.

### SUMMARY OF THE INVENTION

The present invention discloses a novel “high accuracy pulse duty-cycle calculation hardware implementation scheme” and results in pulse duty-cycle calculation hardware that is simple in circuit, high in accuracy, low in cost and suitable for different IC processes.

The high accuracy pulse duty-cycle calculation hardware implementation scheme is composed of a clock generator block, digital pulse width account block, digital memory block to store pulse width in digital and digital-analog divider block with two digital-analog converters. As shown in FIG. 3, the clock generator block is designed to generate the related clock based on pulse width account methods with required accuracy. The digital pulse width account block is used to account the two pulse width of a pulse, e.g. turn-on time T_{ON}, turn-off time T_{OFF}, cycle time Tₛ or other time variable in digital method. The digital memory block is used to store digital information from the digital pulse width account block. As pulse width accounting operation is finished, the digital pulse width account block outputs the digital pulse width information into the digital memory block. The digital memory block will keep digital information until next cycle, that is, equivalent sample-hold function. The digital-analog divider block outputs the ratio of two pulse widths in analog signal based on two stored digital pulse widths from the digital memory block. In the digital-analog divider, there are two digital-analog converters. The concept of the digital-analog divider implement principle is that the output of one digital-analog converter is used as a reference for the other digital-analog converter

The present invention can fully utilize characteristics of the digital and analog mix signal circuit to simplify analog divider structure with digital circuit and simplify digital divider's complicate structure with analog circuit.

With the present invention, it is possible to implement a wide dynamic range pulse width divider.

With the present invention, the pulse width divider can be high in accuracy, low in cost. With the present invention, it is possible to overcome the error of finite word length through different selected pulse width account methods.

### BRIEF DESCRIPTION OF THE DRAWINGS

FIG. 1 is the existing pulse width divider circuit function block diagram

FIG. 2 shows two kinds of pulse sequence time domain plot;

FIG. 3 is the present invention “high accuracy pulse duty-cycle calculation hardware implement scheme” function block diagram

FIG. 4 is the detailed partial embodiment of the “high accuracy pulse duty-cycle calculation hardware implement scheme” function block diagram for clock generator block, digital pulse width account block, digital memory block.

FIG. 5 is the detailed partial embodiment of the “high accuracy pulse duty-cycle calculation hardware implement scheme” function block diagram for digital-analog divider block with two digital-analog converters.

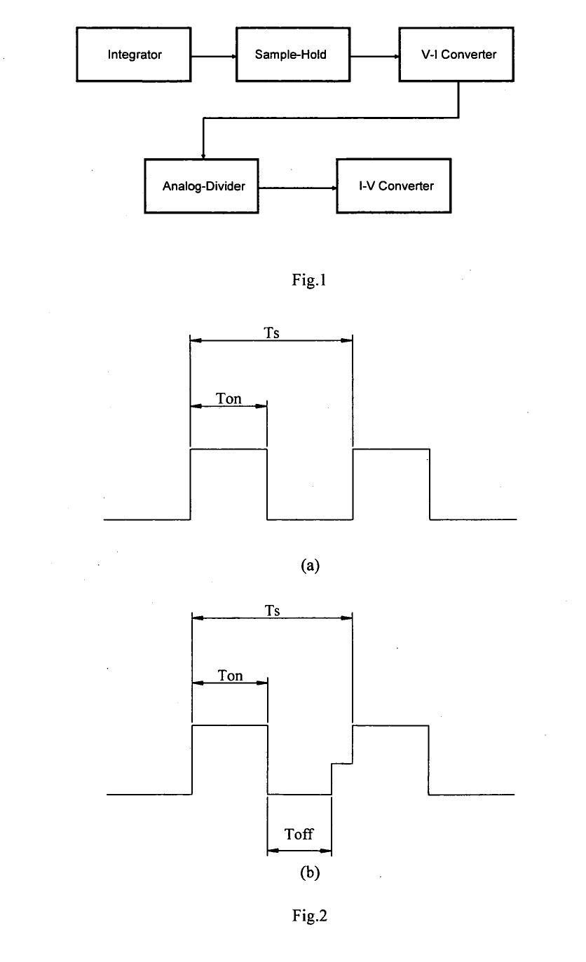

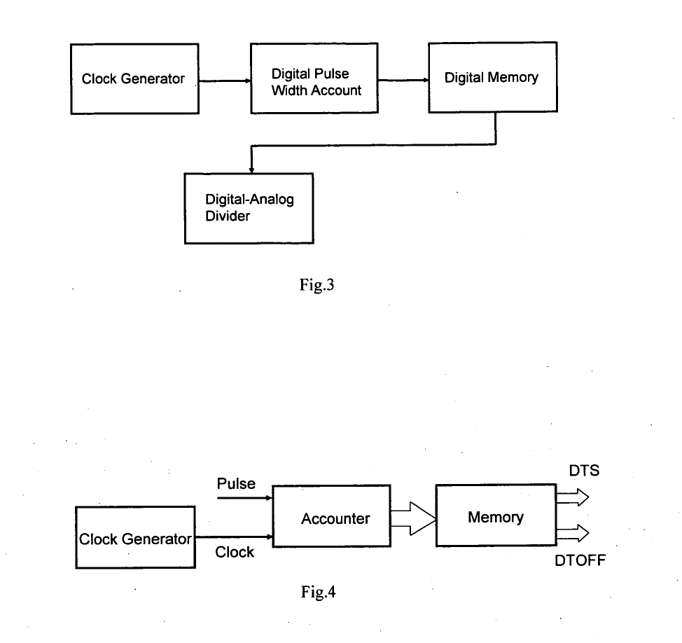

### DETAILED DESCRIPTION OF THE INVENTION

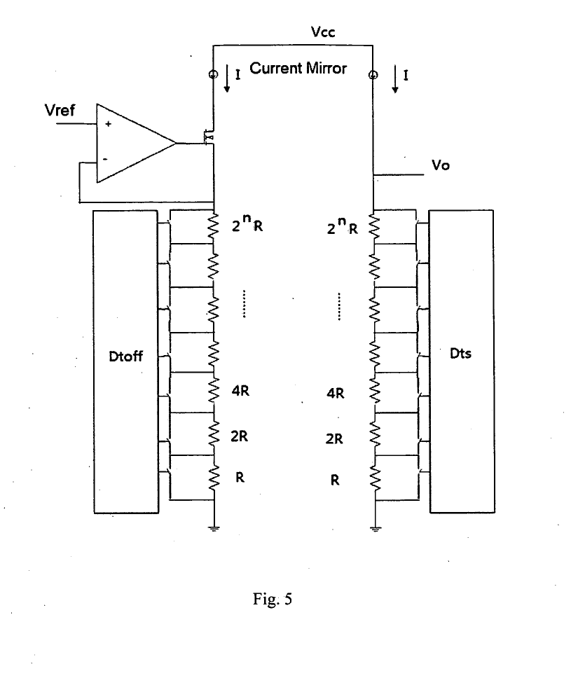

FIGS. 4 and 5 show detailed embodiment of the “high accuracy pulse duty-cycle calculation hardware implement scheme” function block diagram for clock generator block, digital pulse width account block, digital memory block and digital-analog divider block with two digital-analog converters.

The clock generator block, digital pulse width account block, digital memory block can be implemented with regular digital circuit, that is, with digital clock, digital accouter and register.

The digital-analog divider block is composed of operation amplifier A, MOSFET Q, weight resistor network R_{A}, current mirror I_{COUPLE}, weight resistor network R_{B}. The operation amplifier A, MOSFET Q and weight resistor network R_{A} consist of a current source. The output current of the current source is determined with a reference voltage V_{REF} over the weight resistor network R_{A}. The current source is coupled through the current mirror I_{COUPLE} into the weight resistor network R_{B} and generates the related analog voltage, that is, ratio of R_{B} to R_{A}. Both weight resistor network R_{A} and R_{B} are composed of switching resistor network control with a register. The switching resistor network can be changed in binary or another relation based on the selected pulse width account method. It is clear that if the weight resistor network R_{A} and R_{B} are controlled with related digital pulse width T_{ON}, T_{OFF} or T_{S}, the output of digital-analog divider block, that is, the voltage on the weight resistor network R_{B} is the ratio of T_{ON}/T_{OFF} or T_{ON}/T_{S}. The detailed embodiment operation can be as following:

1. To get ratio of the T_{S}/T_{OFF}, here, T_{S} is the cycle of pulse and T_{OFF} is pulse turn-off time. High frequency clock from the clock generator block is used to account pulse width of T_{S} and T_{OFF} separately. The accouter in digital pulse width account block can output related digital value D_{TS} and D_{TOFF}. Digital values of D_{TS} and D_{TOFF} are stored in registers in switching resistor network R_{A} and R_{B}. Due to the same clock to account T_{A} and T_{OFF}, T_{S}/T_{OFF}=D_{TS}/D_{TOFF}. As shown in FIG. 5, if D_{TOFF} is used to control weight resistor network R_{A} and D_{TS} is used to control weight resistor network R_{B}. For a fixed reference V_{REF}, there is a reference current I generated in D_{TOFF} controlled switching resistor network R_{A}. The reference current I is coupled into a reference current I′ through a current mirror. The reference current I′ will generate a voltage on D_{TS} controlled switching resistor network R_{B}. We can got following formulas:

$$I = \frac{{V}_{REF}}{{D}_{TOFF} \cdot R}$$

$${I}^{′} = k \cdot I$$

$${V}_{O} = {I}^{′} \cdot {D}_{TS} \cdot R$$

$${V}_{O} = {V}_{REF} \cdot k \cdot \frac{{D}_{TS}}{{D}_{TOFF}}$$

In formulas, V_{REF} and k are constant. The output voltage V_{O} is the ratio of D_{TS} to D_{TOFF} and is independent of the resistor R in the switching resistor network.

In the embodiment operation detailed above, if two pulse widths have big difference, in order to avoid error of finite word length and obtain a high enough accuracy, there are several methods to account for two pulse widths. For example, two kinds of clock with k times are used to account each pulse width; that means, higher frequency clock is used to account narrow pulse width and lower frequency clock is used to account wide pulse width. Let I′=k*I, in this way, the output ratio from the divider has been k times and due to higher frequency clock to account the narrow pulse width, the error of finite word length for the narrow pulse width can be lower. In order to get higher accuracy with less power loss, there are other methods to account for the pulse width.
2. To get ratio of T_{ON}/T_{S}, here, T_{S} is the cycle of pulse and T_{ON} is pulse turn-on time. The high frequency clock from the clock generator block is used to account pulse width of T_{S} and T_{ON} separately. Accouters in digital pulse width account block can output related digital value D_{TS} and D_{TON}. Digital values of D_{TS} and D_{TON} are stored in registers in switching resistor network R_{A} and R_{B}. Due to the same clock to account T_{S} and T_{ON}, T_{ON}/T_{S}=D_{TON}/D_{TS}. As shown in FIG. 5, if D_{TS} is used to control weight resistor network R_{A}, D_{TON} is used to control weight resistor network R_{B}. For a fixed reference V_{REF}, there is a reference current I generated in D_{TS} controlled switching resistor network R_{A}. The reference current I is coupled into a reference current I′ through a current mirror. The reference current I′ will generate a voltage on D_{TON} controlled switching resistor network R_{B}. We can refer to the following formulas:

$$I = \frac{{V}_{REF}}{{D}_{TS} \cdot R}$$

$${I}^{′} = k \cdot I$$

$${V}_{O} = {I}^{′} \cdot {D}_{TON} \cdot R$$

$${V}_{O} = {V}_{REF} \cdot k \cdot \frac{{D}_{TON}}{{D}_{TS}}$$

In these formulas, V_{REF} and k are constant. The output voltage V_{O} is the ratio of D_{TON} to D_{TS} and is independent of the resistor R in the switching resistor network.

In the above detail embodiment operation, if two pulse widths are hugely different, there are several methods to account two pulse widths in order to avoid the error of finite word length and obtain high enough accuracy . For example, two kinds of clock with k times are used to account each pulse width; that means, the higher frequency clock is used to account for narrow pulse width and lower frequency clock is used to account for wide pulse width. Let I′=k*I. This way, the output ratio from the divider has been k times and due to higher frequency clock to account the narrow pulse width, the error of finite word length for the narrow pulse width can be lower. In order to get higher accuracy with less power loss, there are other methods to account the pulse width.
3. To get T_{OFF}T_{S} or T_{OFF}/T_{ON} or (T_{ON}+T_{OFF})/T_{S}, it can be done in the same as shown above.

What is claimed is:

1. A high accuracy pulse duty-cycle calculation implementation for power converter's PWM control apparatus is composed of a clock generator block, a digital pulse width account block, a digital memory block and a digital-analog divider block with two digital-analog converters;
The clock generator block is designed to generate the related clock based on pulse width account methods with required accuracy;
The digital pulse width account block is used to account the two pulse width of a pulse;
The digital memory block is used to store digital information from the digital pulse width account block until next cycle;
The digital-analog divider block outputs the ratio of two pulse widths in analog signal based on two stored digital pulse widths from the digital memory block, and in the digital-analog divider block, the output of one digital-analog converter is used as a reference for the other digital-analog converter;

2. The high accuracy pulse duty-cycle calculation implementation for power converter's PWM control apparatus claim 1, wherein The digital pulse width account block is used to account the two pulse width of a pulse, e.g. turn-on time T_{ON}, turn-off time T_{OFF}, cycle time T_{S} or other time variable in digital method.

3. The high accuracy pulse duty-cycle calculation implementation for power converter's PWM control apparatus claim 1, wherein the digital memory block is used to store digital information from the digital pulse width account block. The digital memory block will keep digital information until next cycle, that is, equivalent sample-hold function.

4. The high accuracy pulse duty-cycle calculation implementation for power converter's PWM control apparatus claim 1, wherein the digital-analog divider block is composed of a operation amplifier A, MOSFET Q, a weight resistor network R_{A}, current mirror I_{COUPLE}, a weight resistor network R_{B}; The operation amplifier A, MOSFET Q and weight resistor network R_{A} consist of a current source; The output current of the current source is determined with a reference voltage V_{REF} over the weight resistor network R_{A}; The current source is coupled through the current mirror I_{COUPLE} into the weight resistor network R_{B} and generates the related analog voltage, that is, ratio of R_{B} to R_{A}.

5. The high accuracy pulse duty-cycle calculation implementation for power converter's PWM control apparatus claim 4, wherein both weight resistor network R_{A} and R_{B} are composed of switching resistor network control with a register; The switching resistor network can be changed in binary or another relation based on the selected pulse width account method.
